(19) United States
(12) Patent Application Publication
(10) Pub. No.: US 2024/0198765 A1
(43) Pub. Date: Jun. 20, 2024

(54) REFRIGERANT CIRCUIT

(71) Applicant: MAHLE INTERNATIONAL GMBH, Stuttgart (DE)

(72) Inventors: Markus BOGER, Stuttgart (DE); Tobias ISERMEYER, Löwenstein (DE); Johannes LAEPPLE, Waiblingen (DE); Hans-Jörg LOOSER, Aichelberg (DE); Martin PROKSCHA, Stuttgart (DE); Werner SCHADLER, Leibnitz (DE); Bernd VAN EICKELS, Esslingen am Neckar (DE)

(21) Appl. No.: 18/543,400

(22) Filed: Dec. 18, 2023

(30) Foreign Application Priority Data
Dec. 19, 2022 (DE) 102022213920.8

(51) Int. Cl. B60H 1/32

(52) U.S. Cl. CPC B60H 1/3227; B60H 1/3228; B60H 2001/2271

(57) ABSTRACT

The present invention relates to a refrigerant circuit, in particular for a motor vehicle, through which a refrigerant circulates when in operation, and which contains heat exchangers, through which the refrigerant can flow. A simplified implementation resulting in a more efficient refrigerant circuit is obtained with the use of a combination valve, which has a valve element assembly with at least one valve element, and a housing, in which the valve element assembly can be switched between settings, wherein the valve element assembly allows or blocks the flow of the refrigerant to at least three of the heat exchangers in the various settings.

### CROSS-REFERENCE TO RELATED APPLICATIONS

This application claims priority from German Patent Application No. 102022213920.8, filed Dec. 19, 2022, the entirety of which is hereby fully incorporated by reference herein.

The present invention relates to a refrigerant circuit, in particular for a motor vehicle, which contains a heat exchanger, and through which a refrigerant, in particular R744, circulates during operation.

A circuit through which a refrigerant circulates during operation can be used to cool an interior. Heat exchangers are normally incorporated in such refrigerant circuits. When flowing through the heat exchanger for cooling purposes, heat is exchanged between the refrigerant and the environment, the air that is to be supplied to the interior, and a second temperature control fluid such as a coolant, that is separated from the refrigerant. If an application in which the refrigerant circuit is used is at least partially powered with electricity, it is desirable to reduce the power consumption needed for cooling purposes. In the case of a motor vehicle, the reduction in power consumption can contribute to increasing the travel range of a motor vehicle that is at least partially powered with electricity.

One possibility with which this could be achieved is to operate the refrigerant circuit, specifically the heat exchanger, in the manner of a heat pump in which heat is exchanged between the environment and the refrigerant.

There are different modes in which the refrigerant circuit can be operated, in which the refrigerant flows through the refrigerant circuit, and in particular the heat exchangers, in a variety of specific ways. Specific paths through the refrigerant circuit can be opened and closed in the refrigerant circuit to obtain these different operating modes.

The object of the present invention is to create an improved, or at least different, embodiment of a refrigerant circuit like that described above, with which disadvantages from the prior art are eliminated. In particular, the object of the present invention is to create an improved, or at least different, embodiment of the refrigerant circuit, which has a simpler construction and functions more efficiently.

This problem is solved according to the invention by the subject matter of the independent claim 1. Advantageous embodiments are the subject matter of the dependent claims.

The present invention is therefore based on the general idea of using a combination valve in a refrigerant circuit through which a refrigerant circulates when in operation, and in which heat exchangers are incorporated to control different flows through the refrigerant circuit, thereby obtaining different operating modes of the refrigerant circuit with which the distribution of the refrigerant in the refrigerant circuit is regulated. Unlike with the use of numerous individual valves, the use of this combination valve means that only one valve needs to be adjusted to switch between different operating modes. This not only simplifies the refrigerant circuit, but also increases the efficiency thereof. When the refrigerant circulating through the refrigerant circuit is pressurized, it is also easier to effectively seal a combination valve than it is to seal numerous valves. In addition to the simplification, undesired flows potentially caused by poor sealing can be more easily and effectively prevented with the combination valve, such that the refrigerant circuit is ultimately more efficient.

The idea of the invention is that a refrigerant circulates through the refrigerant circuit when in operation. The refrigerant circuit, also referred to below as simply the circuit, also contains a heat exchanger in which heat is exchanged with the refrigerant. The refrigerant circuit contains a heat exchanger for exchanging heat between the refrigerant and the environment, in particular the ambient air, which shall also be referred to as an exterior heat exchanger below. The circuit also contains a heat exchanger for exchanging heat between the refrigerant and a temperature control fluid, e.g. a coolant, that flows in a separate path through the heat exchanger. This heat exchanger functions in the manner of a so-called “chiller,” and is also referred to below as a chiller heat exchanger, or simply a chiller. Another heat exchanger exchanges heat between the refrigerant and air that is to be supplied to an interior. This heat exchanger acts as an evaporator, in particular for cooling the air, and thus transferring heat to the refrigerant. This heat exchanger is also referred to below as an evaporator heat exchanger. Another heat exchanger also exchanges heat between the refrigerant and the air that is to be supplied to the interior, and functions in the manner of a gas cooler.

This heat exchanger is also referred to below as a gas cooler heat exchanger. The gas cooler heat exchanger is used to heat the air, thus cooling the refrigerant. The various heat exchangers contain intakes through which refrigerant is introduced into the heat exchangers, and outlets, through which the refrigerant exits the heat exchanger. A compressor in the circuit pressurizes the refrigerant when in operation, such that the refrigerant circulates through the circuit. The circuit also contains a combination valve, which has a fluid connection to the compressor at the pressure end of the compressor through an entry, such that the compressor causes pressurized refrigerant to flow toward the first entry. This entry in the combination valve is also referred to below as the first entry. The combination valve has a valve element assembly that contains at least one valve element. The combination valve also has a housing containing the valve element assembly such that it can be adjusted. The combination valve is designed such that the valve element assembly can be set to allow or block the flow of the refrigerant to at least three of the heat exchangers, such that the refrigerant is distributed in the refrigerant circuit by the combination valve.

The distribution of the refrigerant in the circuit and therefore the implementation of various operating modes of the refrigerant circuit therefore takes place at least in part, preferably entirely, by means of the combination valve.

The refrigerant is advantageously a refrigerant that contains CO₂. Specifically, the refrigerant can be CO₂ or R744. The refrigerant therefore has a potentially low evaporation temperature. The refrigerant circuit can consequently be operated efficiently, in particular with the exterior heat exchanger functioning as a heat pump for obtaining heat from the environment, even with low ambient temperatures. This increases the efficiency. Moreover, because of the increased operating pressure that is necessary, more effective sealing can be obtained with the combination valve, such that only one valve element is needed. This results in a simpler and more efficient implementation.

The circuit contains fluid connections with which the compressor is connected to the combination valve, the combination valve is connected to the intakes and outlets in the heat exchangers, and the heat exchangers are connected to one another.

In addition to the first entry, the combination valve advantageously also has at least one other entry through which refrigerant can flow into the combination valve.

In addition to at least one entry, the combination valve contains at least two exits through which refrigerant flowing through the combination valve can exit.

The entries and exits in the combination valve are advantageously all located or formed on the same housing.

In preferred embodiments, the combination valve has three entries and four exits. This means that, in addition to the first entry, the combination valve has two other entries, specifically a second entry and a third entry.

The second entry has a fluid connection to the outlet in the gas cooler heat exchanger. The third entry has a fluid connection to the outlet on the exterior heat exchanger. A first exit has a fluid connection to the intake in the gas cooler heat exchanger. A second exit has a fluid connection to the intake in the exterior heat exchanger. A third exit has a fluid connection to the intake in the evaporator heat exchanger. A fourth exit has a fluid connection to the compressor at the suction end of the compressor.

The entries in the combination valve advantageously each have at least one dedicated exit in the combination valve, or vice versa. It is preferred when the refrigerant flowing through an entry in the combination valve can only flow out of the combination valve through its at least one dedicated exit. This simplifies the distribution of the refrigerant in the circuit by means of the combination valve, such that different operating modes of the circuit can be easily implemented.

The first exit and the second exit are preferably dedicated to the first entry. This means that refrigerant flowing into the combination valve through the first entry can only flow out of the combination valve through the first exit and/or the second exit.

The third exit is preferably dedicated to the second entry. This means that refrigerant flowing into the combination valve through the second entry can only flow out of the combination valve through the third exit.

The fourth exit is preferably dedicated to the third entry. This means that refrigerant flowing into the combination valve through the third entry can only flow out of the combination valve through the fourth exit.

In preferred embodiments, the evaporator heat exchanger and/or the chiller heat exchanger, preferably both heat exchangers, each have a dedicated upstream expansion valve, with which a reduction in the pressure and/or temperature is obtained before flowing into the heat exchangers. This results in an improvement in the functioning of the evaporator and the chiller, preferably by absorbing heat from the refrigerant in the evaporator and in the chiller.

In advantageous embodiments, the outlet in the gas cooler heat exchanger and the intake in the exterior heat exchanger have a fluid connection to one another. The refrigerant can therefore flow out of the outlet in the gas cooler heat exchanger into the intake in the exterior heat exchanger.

In preferred embodiments, the outlet in the evaporator heat exchanger has a fluid connection to the suction end of the compressor. Consequently, refrigerant flowing out of the evaporator heat exchanger then flows into the compressor, or is drawn into it.

In advantageous embodiments, the evaporator heat exchanger is upstream of the gas cooler heat exchanger with regard to the flow of air to be conducted into the interior. The air that is to be conducted into the interior therefore flows through the evaporator heat exchanger and subsequently through the gas cooler heat exchanger. This allows the evaporator heat exchanger to first cool the air and thus potentially dehumidify the air, after which it is heated by the gas cooler heat exchanger and introduced into the interior.

Embodiments in which the outlet in the exterior heat exchanger have a fluid connection to the intake in the chiller heat exchanger are preferred. This allows for the refrigerant flowing out of the exterior heat exchanger to flow into the chiller heat exchanger.

There is preferably a fluid connection between the outlet in the exterior heat exchanger and the intake in the chiller heat exchanger for this that bypasses the combination valve, which is referred to as a bypass connection below.

Embodiments in which the outlet in the evaporator heat exchanger has a fluid connection to the suction end of the compressor are advantageous. This connection is referred to below as a return connection.

The outlet in the chiller preferably has a fluid connection to the return connection downstream of the outlet in the evaporator.

A heat exchanger is advantageously interconnected between the bypass connection and the return connection, through which refrigerant therefore flows. This heat exchanger therefore functions as an internal heat exchanger.

A battery in the associated application, in particular a motor vehicle, can also be incorporated in the bypass connection and/or return connection, instead of, or in addition to, the internal heat exchanger, through which refrigerant therefore flows in order to cool and/or heat the battery as needed.

Embodiments in which the outlet in the chiller heat exchanger has a fluid connection to the suction end of the compressor are preferred. The refrigerant flowing out of the chiller then flows to the compressor, or is drawn into the compressor.

Embodiments are also preferred in which the outlet in the exterior heat exchanger has a fluid connection, preferably through the bypass connection, to the intake in the evaporator heat exchanger. Refrigerant flowing out of the exterior heat exchanger can then flow to the evaporator and subsequently to the compressor.

The valve element assembly is preferably designed such that it has a fluid connection from the first entry to the second exit in a first setting, referred to as the cooling setting below. In the cooling setting, the other entries are disconnected from the exits. This means that refrigerant can only flow into the combination valve through the first entry and out of the combination valve through the second exit in the cooling setting.

The cooling setting of the combination valve preferably results in a corresponding operating mode of the refrigerant circuit, which is referred to below as the cooling mode. The interior can be cooled in the cooling mode.

The refrigerant that is pressurized by the compressor flows to the first entry in the combination valve in the cooling mode. The refrigerant bypasses the gas cooler heat exchanger in the cooling setting, i.e. it flows around the gas cooler heat exchanger, and through the second exit into the exterior heat exchanger. The refrigerant is cooled in the exterior heat exchanger by discharging heat into the environment. The refrigerant subsequently flows to the evaporator heat exchanger and/or chiller heat exchanger where it is then depressurized and cooled at the expansion valve. This allows the refrigerant to absorb heat in the evaporator heat exchanger and in the chiller heat exchanger. The refrigerant subsequently flows back to the pressure end of the compressor.

The valve element assembly is preferably designed such that it has a fluid connection from the first entry to the first exit in another setting, referred to below as the first heating setting. The valve element assembly also has a fluid connection from the second entry to the third exit and the third entry to the fourth exit when in the first heating setting. The other entries are disconnected from the exits. The refrigerant pressurized by the compressor therefore flows in the first heating setting through the first entry to the first exit, and subsequently to the intake in the gas cooler heat exchanger. The refrigerant subsequently flows through the outlet in the gas cooler heat exchanger to the second entry and through the second entry to the third exit. The refrigerant then flows into the evaporator heat exchanger through the fluid connection between the third exit and the entry in the evaporator heat exchanger. The refrigerant preferably also flows back to the compressor through the outlet in the evaporator heat exchanger. The refrigerant also preferably flows through the outlet in the gas cooler heat exchanger to the intake in the exterior heat exchanger and through the outlet in the exterior heat exchanger to the third entry. The refrigerant then flows from the third entry to the fourth exit and consequently back to the compressor.

In the first heating setting, the refrigerant circuit is operated in a first heating mode. Heat is transferred in the first heating mode through the exterior heat exchanger from the environment to the refrigerant, such that the exterior heat exchanger functions as a heat pump. It is possible to heat and/or dehumidify the air to be supplied to the interior in the heating mode. In this case, the air that is to be supplied to the interior is first cooled and dehumidified by the evaporator heat exchanger, and subsequently heated, preferably in the gas cooler heat exchanger. Heat is preferably also transferred to the refrigerant in the chiller heat exchanger in the first heating mode. This means that heat is also preferably transferred from a temperature control fluid, in particular a coolant, to the refrigerant in the first heating mode.

The valve element assembly is designed in advantageous embodiments such that it has a fluid connection from the first entry to the first exit in another setting, referred to as the second heating setting below. The valve element assembly also has a fluid connection from the second entry to the third exit in the second heating setting. The other entries are disconnected from the exits by the valve element assembly. The second heating setting therefore resembles the first heating setting, with the exception that the refrigerant is unable to flow into the third entry. This prevents the refrigerant from flowing through the exterior heat exchanger in the second heating setting.

In the second heating setting, the refrigerant circuit is operated in a second heating mode, which resembles the first heating mode with the exception that no heat is transferred to the refrigerant in the exterior heat exchanger. It is also possible to dehumidify and heat the air that is to be supplied to the interior in the second heating setting.

In advantageous embodiments, the valve element assembly is designed such that it has a fluid connection from the first entry to the first exit and disconnects the other entries from the exits in another setting, which is referred to as the defrost setting below. The refrigerant therefore flows to the first entry and subsequently through the first exit to the intake in the gas cooler heat exchanger in the defrost setting. The refrigerant subsequently flows through the outlet in the gas cooler heat exchanger to the exterior heat exchanger and through the outlet in the exterior heat exchanger to the chiller heat exchanger, and through the outlet in the chiller heat exchanger back to the compressor.

In the defrost setting, the refrigerant circuit is operated in a defrost mode. Heat is transferred to the refrigerant in the chiller heat exchanger in the the defrost mode. The refrigerant also discharges heat in the gas cooler heat exchanger and the exterior heat exchanger. The air that is to be supplied to the interior is therefore heated, such that defrosting takes place in the exterior heat exchanger.

The refrigerant also flows through the evaporator heat exchanger in the defrost mode in preferred embodiments, in order to first cool and dehumidify the air that is to be supplied to the interior before it flows through the gas cooler heat exchanger.

The at least one valve element can have any design, as long as in at least one of the settings it opens or closes the right fluid connection.

The at least one valve element regulates at least one flow path in the housing in preferred embodiments, which has a fluid connection from one of the entries to one of the exits in at least one of the settings of the valve element assembly. By adjusting the valve element, the flow path is therefore adjusted, such that the flow path has a fluid connection from one of the entries to one of the exits in at least one of the settings.

In preferred embodiments, the flow path can only connect one of the entries to one of the exits. This means that the flow path in question connects the specific entry to its associated exit in one setting, and disconnects them in the other settings. This results in a simplified design of the valve element assembly, and a reliable flow regulation within the combination valve, thus resulting in a reliable operation of the refrigerant circuit.

The flow path in question can be obtained in a number of ways, as long as it is regulated inside the housing by the valve element assembly.

At least one of the valve elements can contain a channel passing through it that delimits the flow path.

At least one of the valve elements can have an external recess that delimits this flow path.

The at least one flow path can be delimited by this recess as well as the above channel.

The at least one valve element can be adjusted in a variety of ways in the combination valve.

An adjustment is advantageously understood in the present context to mean a movement in the valve element assembly, i.e. a movement in at least one of the valve elements in the housing.

At least one of the valve elements, preferably the valve element assembly, can be moved in a translatory manner between at least two of the settings, preferably all of the settings. At least one of the valve elements, preferably the valve element assembly, is therefore moved along a line or trajectory in order to switch between the different settings.

At least one of the valve elements, preferably the valve element assembly, is connected to a threading that extends along the path for the translatory movement, such that by rotating the threading, the valve element is moved.

At least one of the valve elements, preferably the valve element assembly, can be moved rotationally between at least two settings, preferably all of the settings. In this case, the at least one valve element, preferably the valve element assembly, is rotated between the different settings.

The combination valve preferably has at least one actuator for the valve element assembly, preferably just one actuator.

The at least one valve element can be in any form, or have any basic design.

At least one of the valve elements can be a cylinder or piston. The valve element in this case is in the shape of a cylinder or piston, in which the above channel and/or recess can be formed.

This cylinder or piston can be moved in the housing in both the translatory as well as rotational directions.

At least one of the valve elements can be a ball valve. The valve element in this case is in the form of a ball in which at least one such channel and/or recess can be formed.

This ball valve can advantageously be rotated between at least two of the settings.

The valve element assembly can theoretically contain any number of valve elements.

In preferred embodiments, the valve element assembly contains a single valve element. This simplifies the design of the combination valve. Moreover, the necessary sealing in the combination valve can be easily and reliably obtained.

The valve element assembly can also contain two valve elements that are connected to one another. This makes it easy to reliably obtain the necessary sealing in the combination valve.

The refrigerant circuit is advantageously used in a motor vehicle for controlling the temperature of the air in the interior of a motor vehicle in which the passengers are accommodated. The refrigerant circuit can therefore be a component in an air conditioning system for the motor vehicle. The exterior heat exchanger exchanges heat with the environment, or the ambient air through which the vehicle travels. The battery can be an electric vehicle battery.

The use of the combination valve in the refrigerant circuit, in particular in a motor vehicle, in particular with a refrigerant containing CO₂, e.g. using CO₂ or R744 as the refrigerant, has the advantage explained above, that the necessary sealing can be obtained in the combination valve, preferably only in the combination valve, such that it is both more effective as well as less expensive.

It should be clear that the refrigerant circuit can contain at least one more valve element and/or at least one more combination valve for regulating flows, in particular of the refrigerant and/or the temperature control fluid.

Other important features and advantages of the invention can be derived from the dependent claims, the drawings, and the associated descriptions in reference to the drawings.

It is understood that the features specified above and explained below can be used not only in the given combinations, but also in other combinations or in and of themselves, without abandoning the scope of the present invention.

Preferred exemplary embodiments of the invention are shown in the drawings and shall be explained below in greater detail, in which the same reference symbols are used for the same or similar, or functionally similar, components.

Therein, schematically:

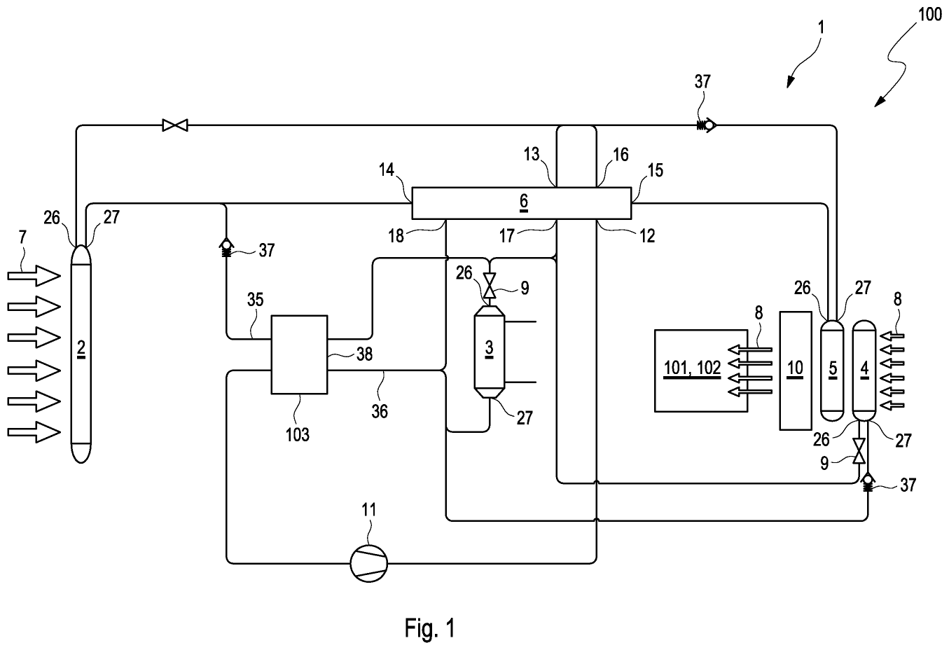

FIG. 1 shows a highly simplified illustration of a refrigerant circuit containing a combination valve in a motor vehicle, in the form of a circuit diagram;

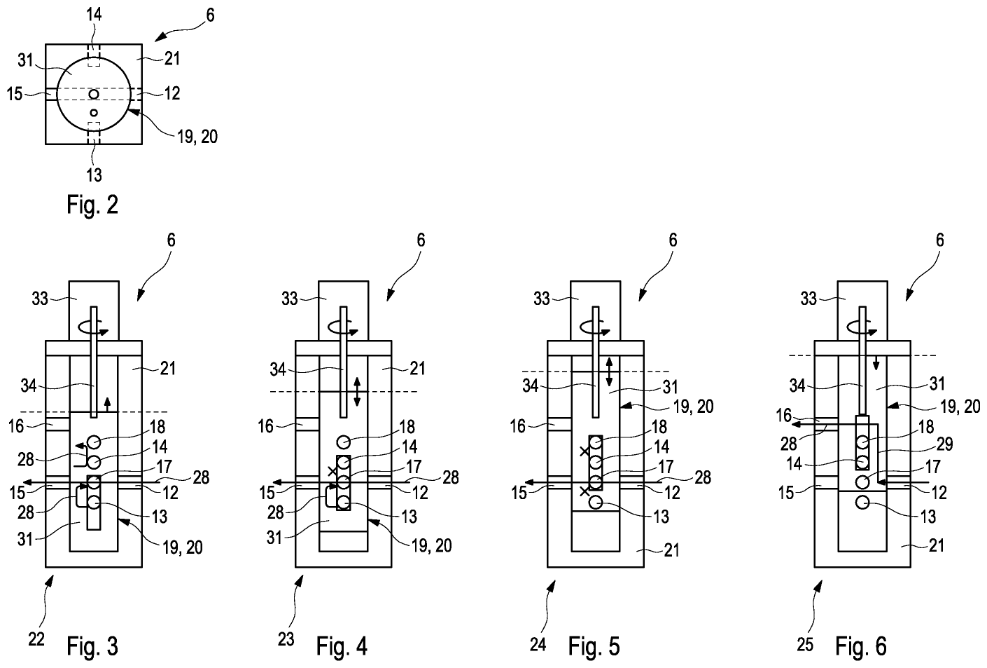

FIG. 2 shows a cutaway through the combination valve, which contains a valve element assembly;

FIGS. 3 to 6 each show a setting of the combination valve in a cutaway through the combination valve;

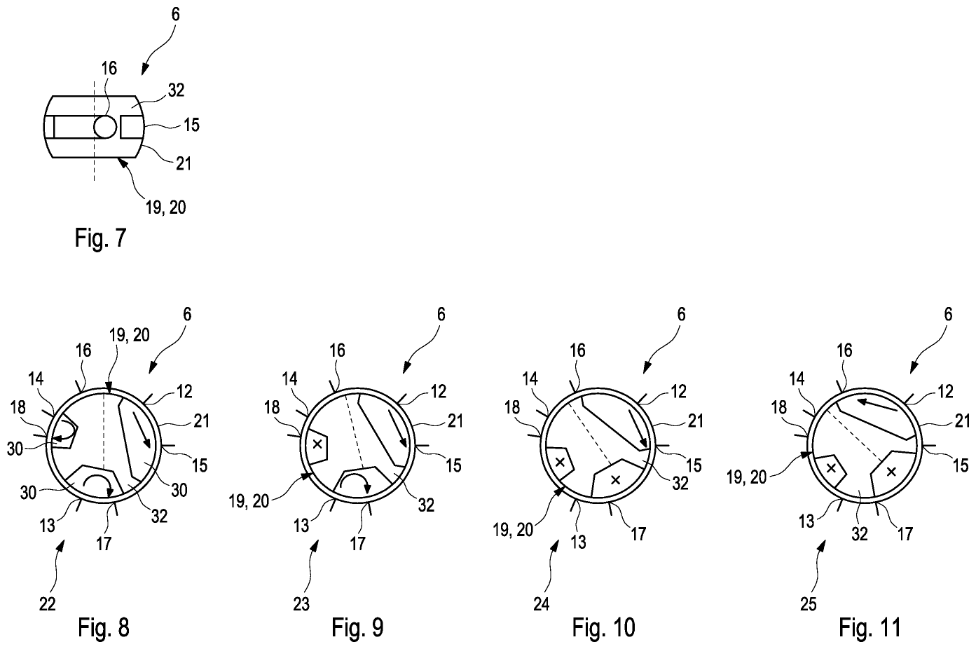

FIG. 7 shows a side view of a valve element in the combination valve, in another exemplary embodiment;

FIGS. 8 to 11 each show a setting of the combination valve in a cutaway through the combination valve;

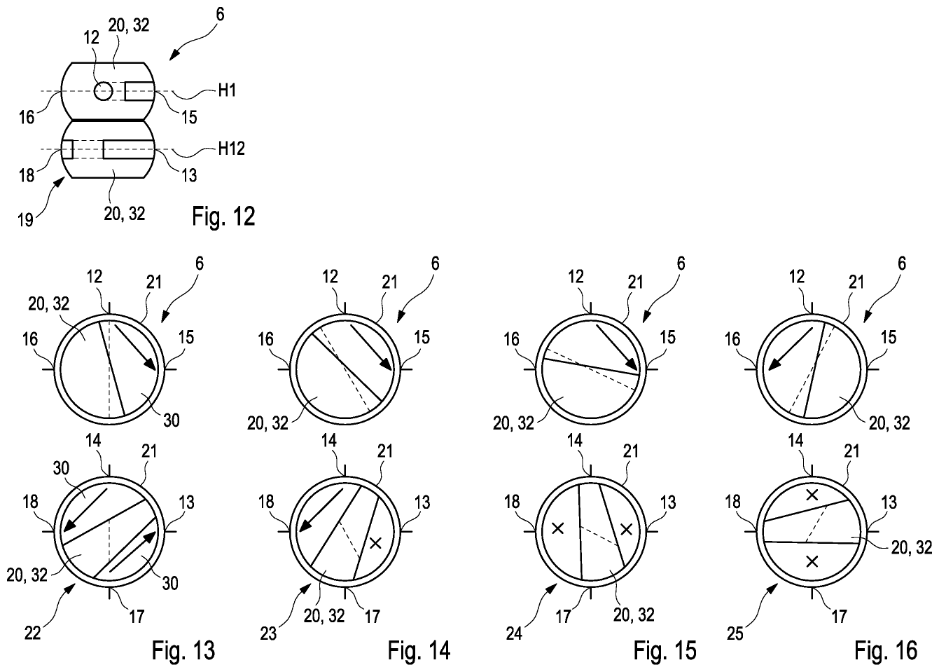

FIG. 12 shows a side view of a valve element in the combination valve in another exemplary embodiment;

FIGS. 13 to 16 each show a setting of the combination valve in a cutaway through the combination valve;

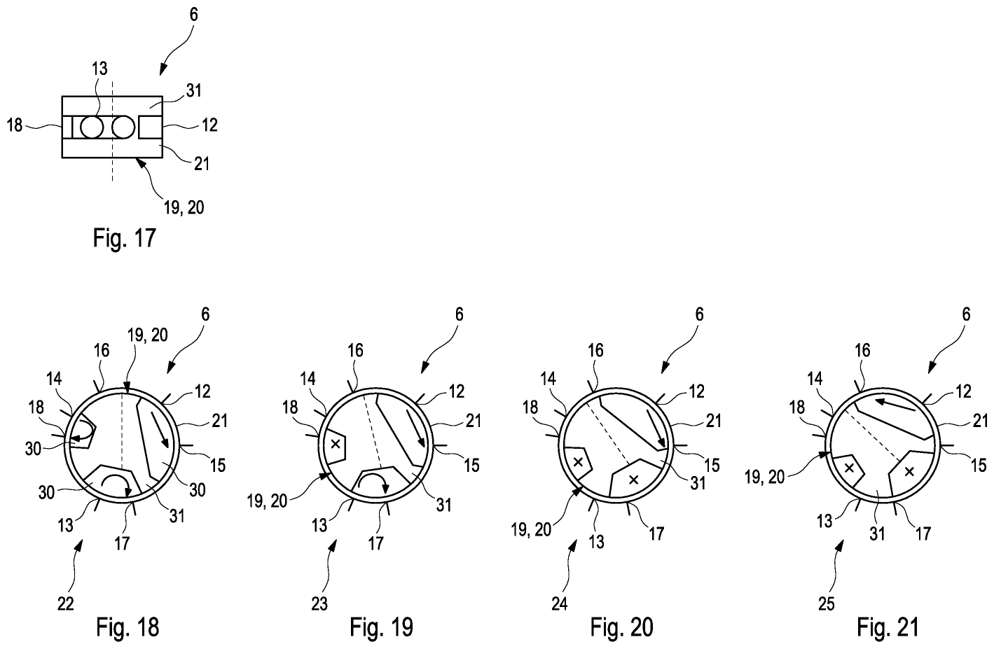

FIG. 17 shows a side view of the valve element in the combination valve in another exemplary embodiment;

FIGS. 18 to 21 each show a setting of the combination valve in a cutaway through the combination valve;

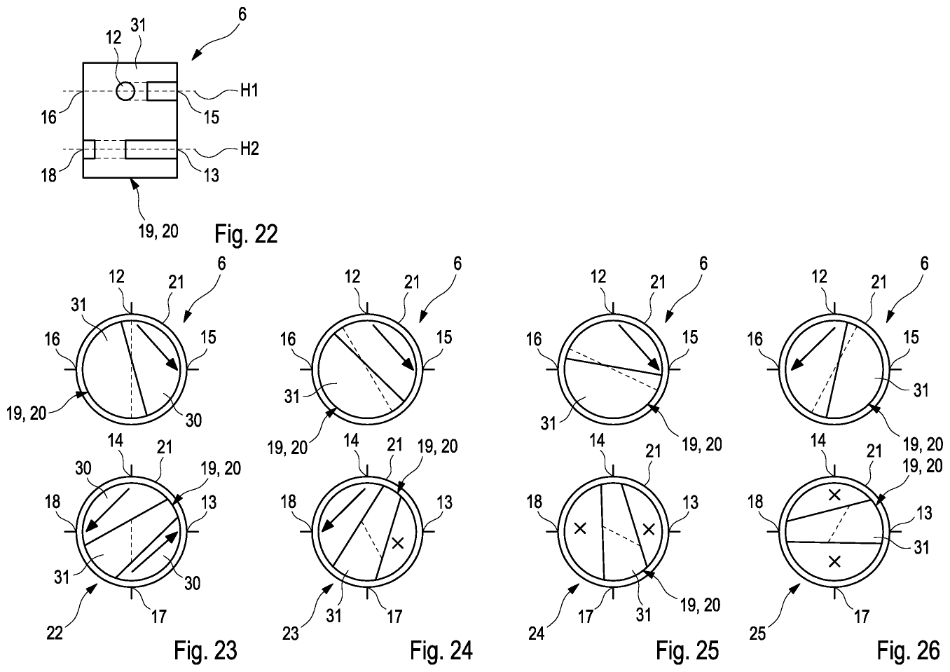

FIG. 22 shows a side view of the valve element in the combination valve in another exemplary embodiment;

FIGS. 23 to 26 each show a setting of the combination valve in a cutaway through the combination valve;

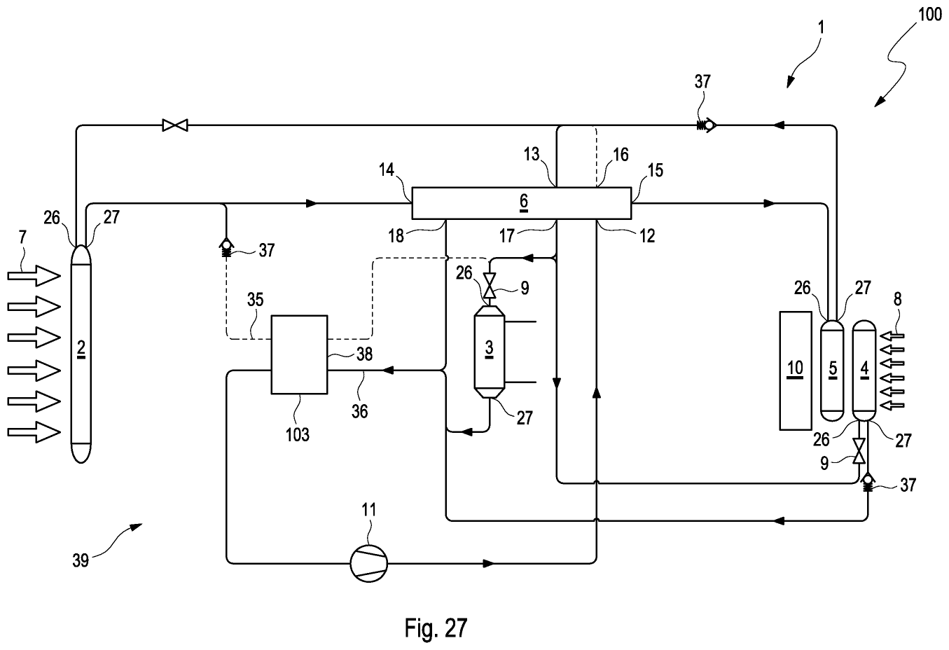

FIG. 27 shows the illustration from FIG. 1 in a first operating mode of the refrigerant circuit;

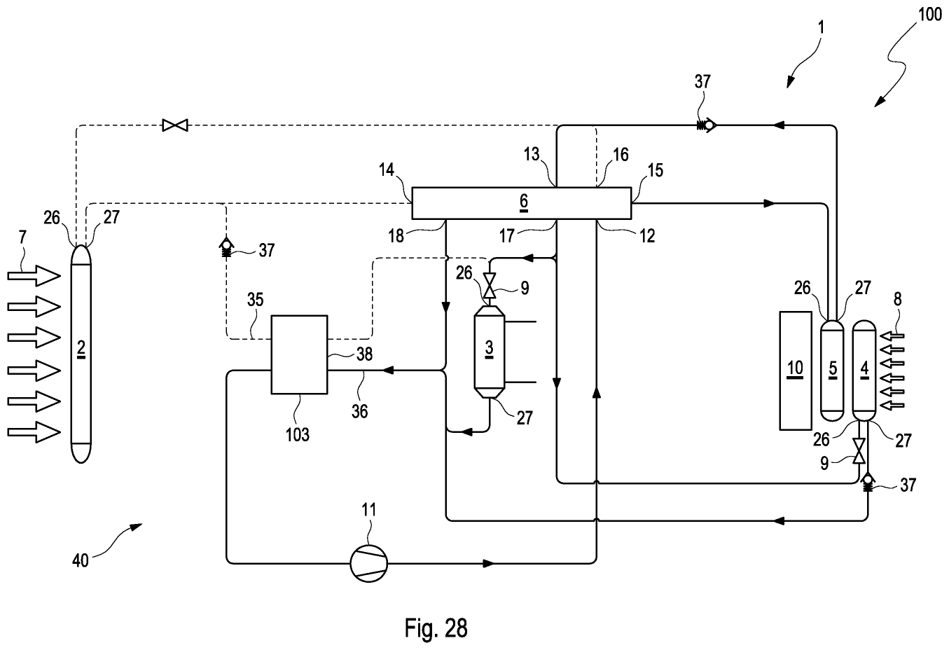

FIG. 28 shows the illustration from FIG. 1 in a second operating mode of the refrigerant circuit;

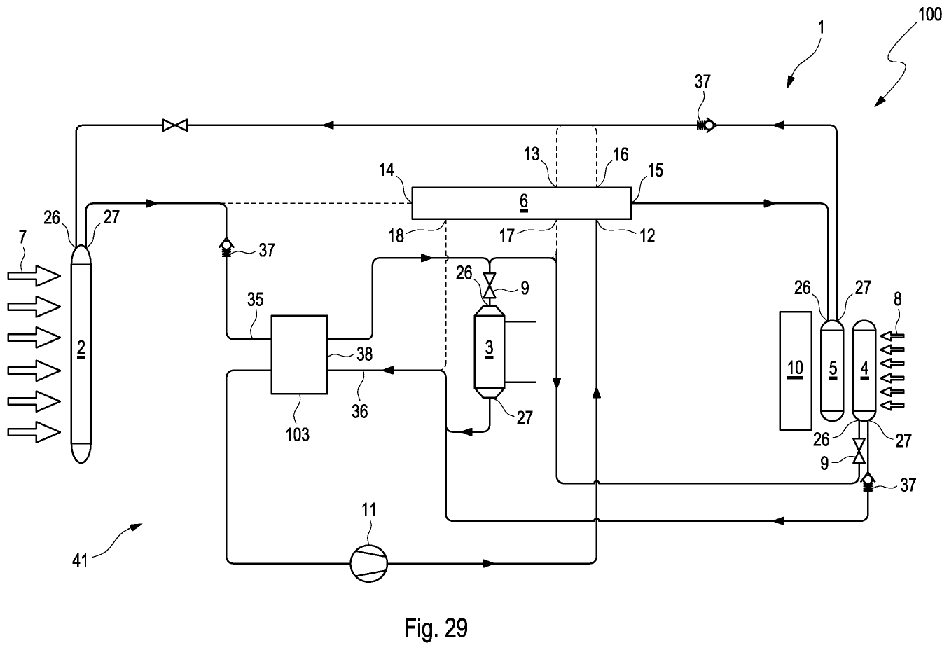

FIG. 29 shows the illustration from FIG. 1 in a third operating mode of the refrigerant circuit; and

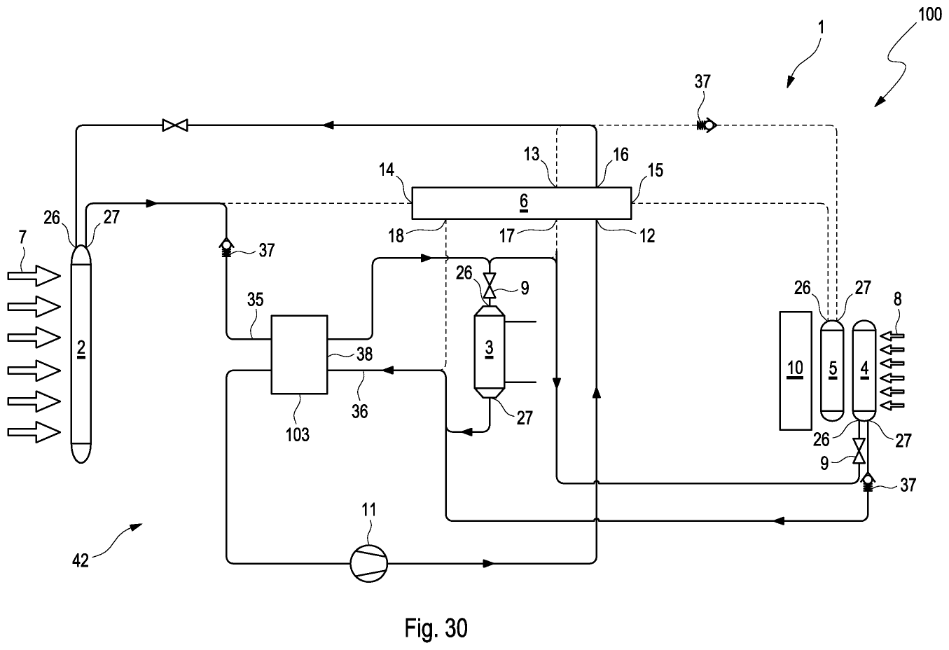

FIG. 30 shows the illustration from FIG. 1 in a fourth operating mode of the refrigerant circuit;

A refrigerant, advantageously a refrigerant containing CO₂, in particular R744, circulates through a refrigerant circuit 1 when in operation, as shown by way of example in FIGS. 1 and 27 to 30. The refrigerant circuit 1, also referred to as a circuit 1 below, is used to control the temperature in an interior 101, merely indicated in FIG. 1. In these exemplary embodiments, the interior 101 is that of a motor vehicle 100. The circuit 1 is therefore used in a motor vehicle 100 to control the temperature of the interior 101 of the motor vehicle 1, i.e. to cool, and/or heat, and/or dehumidify the interior. The interior 101 in these exemplary embodiments is the passenger compartment 102 in the motor vehicle 100. The motor vehicle 100 in these exemplary embodiments is a vehicle 100 that is powered at least in part with electricity. The vehicle 100 has an electric vehicle battery 103 for this.

The circuit 1 contains heat exchangers 2, 3, 4, 5, which are incorporated in the circuit 1 such that refrigerant can flow through them when in operation. Each heat exchanger 2, 3, 4, 5 contains one intake 26 and one outlet 27 through which the refrigerant enters the heat exchangers 2, 3, 4, 5 and exits the heat exchangers 2, 3, 4, 5 respectively. The circuit 1 also contains a combination valve 6 with which the flow of refrigerant through the circuit 1 is controlled, thus distributing the refrigerant in the circuit 1. One of the heat exchangers 2 is used to exchange heat between the refrigerant and the environment, in particular the ambient air 7 indicated by arrows in FIGS. 1 and 27 to 30. This heat exchanger 2 is also referred to as the exterior heat exchanger 2. Another heat exchanger 3 is used exchange heat between the refrigerant and a temperature control fluid that flows through the heat exchanger 3, as indicated in FIGS. 1 and 27 to 30. The temperature control fluid, which is a coolant for example, flows through the heat exchanger 3 separately from the refrigerant. This heat exchanger 3 is also referred to below as a chiller heat exchanger 3. Another heat exchanger 4 is used to exchange heat between the refrigerant and the interior 102 by controlling the temperature of the air 8 that is to be supplied thereto, indicated by arrows in FIGS. 1 and 27 to 30. This heat exchanger 4 functions as an evaporator for the refrigerant and is also referred to below as the evaporator heat exchanger 4. In particular, the evaporator heat exchanger 4 cools the air 8 supplied to the interior 101. As can be seen in FIGS. 1 and 27 to 30, the chiller heat exchanger 3 and the evaporator heat exchanger 4 each have a dedicated upstream expansion valve 9, through which the refrigerant flows prior to flowing into the chiller heat exchanger 3 and the evaporator heat exchanger 4, thus reducing the pressure and temperature of the refrigerant. Another heat exchanger 5 is used to exchange heat between the refrigerant and the air that is to be supplied to the interior. This heat exchanger 5 is also referred to below as a gas cooler heat exchanger 5. The gas cooler heat exchanger 5 in these exemplary embodiments is downstream of the evaporator heat exchanger 4 in relation to the flow of the air 8 that is to be supplied to the interior 101. As can be seen in FIGS. 1 and 27 to 30, there can also be an electric heater 10 that heats the air 8 to be supplied to the interior 101 as needed. The electric heater 10 in these exemplary embodiments is upstream of the gas cooler heat exchanger 5 in relation to the flow of the air 8 that is to be supplied to the interior 101. The circuit 1 also contains a compressor 11 for pressurizing and thus driving the refrigerant. The refrigerant pressurized by the compressor 11 flow to the combination valve 6 and is then distributed by the combination valve 6 in the circuit 1 in that the refrigerant is either allowed to or prevented from flowing through the various heat exchangers 2, 3, 4, 5, as shall be explained below. An entry 12 in the combination valve 6 has a fluid connection to the compressor 11 at the pressure end of the compressor 11 for this purpose. This entry 12 is also referred to below as the first entry 12.

The combination valve 6 contains a valve element assembly 19 with at least one valve element 20, as can be seen in FIGS. 2 to 26. The combination valve 6 also has a housing 21 in which the valve element assembly 19 is located such that it can be adjusted. The combination valve 6 is designed such that the valve element assembly 19 allows or prevents the flow of refrigerant to at least three of the heat exchangers 2, 3, 4, 5 in these exemplary embodiments in the various settings 22, 23, 24, 25, such that the refrigerant is distributed in the circuit 1 by the combination valve 6.

The combination valve 6 has a total of three entries 12, 13, 14 in these exemplary embodiments, specifically the first entry 12, a second entry 13, and a third entry 14, through which the refrigerant can flow into the combination valve 6. The combination valve 6 also has a total of four exits 15, 16, 17, 18 in these exemplary embodiments.

The second entry 13 has a fluid connection to the outlet 27 in the gas cooler heat exchanger 5 in these exemplary embodiments. The third entry 14 has a fluid connection to the outlet 27 in the exterior heat exchanger 2. The first exit 15 is has a fluid connection to the entry 26 in the gas cooler heat exchanger 5. The second exit 16 has a fluid connection to the intake 26 in the exterior heat exchanger 2. The third exit 17 has a fluid connection to the intake 26 in the evaporator heat exchanger 4. The fourth exit 18 has a fluid connection to the compressor at the suction end of the compressor 11. Each of the exits 15, 16, 17, 18 in these exemplary embodiments has just one dedicated entry 12, 13, 14. This means that refrigerant flowing out of the respective exits 15, 16, 17, 18 can only flow into the combination valve 6 through its dedicated entry 12, 13, 14. In these exemplary embodiments, the first entry 12 is dedicated to both the first exit 15 and the second exit 16, such that refrigerant pressurized by the compressor 11 can flow through the first entry 12 into the combination valve 6 and subsequently through the first exit 15 or the second exit 16 out of the combination valve 6. The second entry 13 is dedicated to the third exit 17 in these exemplary embodiments, such that refrigerant flowing through the second entry 13 into the combination valve 6 can only exit the combination valve 6 through the third exit 17. The third entry 14 is dedicated to the fourth exit 18 in these exemplary embodiments, such that refrigerant flowing into the combination valve 6 through the third entry 14 can only exit the combination valve 6 through the fourth exit 18.

The valve element assembly 19 in these exemplary embodiments has either a single valve element 20 or just two valve elements 20. The valve element assemblies 19 in the exemplary embodiments shown in FIGS. 2 to 6, 7 to 11, 17 to 21, and 22 to 26 have a single valve element 20. The valve element assemblies 19 shown in FIGS. 12 to 16 have just two valve elements 20, which are connected to one another.

The valve element assemblies 19 in these exemplary embodiments have dedicated flow paths 28 for the exits 15, 16, 17, 18 dedicated to the entries 12, 13, 14, which are limited to the interior of the housing 21 and form a fluid connection between each of the exits 15, 16, 17, 18 and its associated entry 12, 13, 14. The at least one valve element 20 therefore delimits at least one of these flow paths 28 within the housing 21. At least one of the flow paths 28 can be delimited in the associated valve body 20 by a channel 29 extending through the valve element 20, as can be seen in FIG. 6. At least one of the valve elements 20 can also contain a recess 30 formed on the outside thereof, which delimits such a flow path, as can be seen in FIGS. 8 to 11, by way of example.

The valve element 20 is formed by a piston 31 or cylinder 31 in the exemplary embodiments shown in FIGS. 2 to 6, 17 to 21, and 22 to 26. The at least one valve element 20 shown in FIGS. 7 to 11 and 12 to 16 is formed by a ball valve 32.

The valve element assemblies 19 in the exemplary embodiments shown in FIGS. 2 to 6 are switched between the settings 22, 23, 24, 26 in a translatory manner. The valve element assemblies 19 in the exemplary embodiments shown in FIGS. 7 to 26 are rotated between the settings 22, 23, 24, 26.

An actuator, shown only in FIGS. 3 to 6, which is preferably operated electrically, is used to switch the valve element assemblies between the settings 22, 23, 24, 25.

As can be seen in FIGS. 2 to 6, the valve element assembly 19 can be connected to a threading 34 that extends along the translatory adjustment path, such that rotating the threading 34 results in an adjustment of the valve element assembly 19. The actuator 33 then turns the threading 34 for this.

The flow paths 28 in the valve element assembly 19 can all be at substantially the same level, as can be seen in the exemplary embodiments shown in FIGS. 7 to 11 and 17 to 21.

FIGS. 2, 7, 12, 17 and 22 each show longitudinal cuts through the combination valve 6, and in particular through the valve element assemblies 19.

FIGS. 3 to 6, 8 to 11, 13 to 16, 18 to 21 and 23 to 26 each show cross sections through the valve element assemblies 19.

The flow paths 28 through the valve element assemblies can be at different levels, as can be seen in the exemplary embodiments shown in FIGS. 2 to 6, 12 to 16, and 22 to 26. In these exemplary embodiments, the flow paths 28 are substantially at two different levels. There are two cutaways shown in FIGS. 13 to 16, the upper of which is at the first level H1 indicated in FIG. 12, and the lower of which is at the second level H2 indicated in FIG. 12. FIGS. 22 to 26 also show two cutaways, the upper of which is at the first level H1 indicated in FIG. 22, and the lower of which is at the second level H2 indicated in FIG. 22.

The valve element assembly 19 can be switched between four settings 22, 23, 24, 25 in these exemplary embodiments. The flow paths 28 that are open in the various settings 22, 23, 24, 25 are indicated in the by an arrow, and those flow paths 28 that are blocked are indicated by an “x.”

FIGS. 3, 8, 13, 18 and 23 show a first setting 22 of the valve element assembly 19. The first setting 22 is referred to below as the first heating setting 22. The valve element assembly 19 has a fluid connection from the first entry 12 to the first exit 15 and the second entry 13 to the third exit 17, as well as the third entry 14 14 to the fourth exit 18 in the first heating setting 22. The valve element assembly 19 otherwise disconnects the entries 12, 13, 14 from the other exits 15, 16, 17, 18.

FIGS. 4, 9, 14, 19 and 24 show a second setting 23 of the valve element assembly 19. The second setting 23 is also referred to below as the second heating setting 23. The valve element assembly 19 has a fluid connection from the first entry 12 to the first exit 15, and the second entry 13 to the third exit 17 in the second heating setting 23. The valve element assembly 19 otherwise disconnects the entries 12, 13, 14 from the other exits 15, 16, 17, 18.

FIGS. 5, 10, 15, 20, and 25 show a third setting 24 of the valve element assembly 19. The third setting 24 is also referred to below as the defrost setting 24. The valve element assembly 19 has a fluid connection from the first entry 12 to the first exit 15 in the defrost setting 24, and otherwise disconnects the entries 12, 13, 14 from the other exits 15, 16, 17, 18.

FIGS. 6, 11, 16, 21 and 26 show a fourth setting 25 of the valve element assembly. The fourth setting 26 is also referred to below as the cooling setting 25. The valve element assembly 19 has a fluid connection from the first entry 12 to the second outlet 26 in the cooling setting 25, and otherwise disconnects the entries 12, 13, 14 from the other exits 15, 16, 17, 18.

As can be seen in FIG. 1, for example, the outlet 27 in the gas cooler heat exchange 5 and the intake 26 in the exterior heat exchanger 2 have fluid connections in the exemplary embodiments shown herein. The outlet 27 in the evaporator heat exchanger 4 also has a fluid connection to the compressor 11 at the suction end of the compressor 11 in these exemplary embodiments, such that refrigerant flows from the evaporator heat exchanger 4 to the compressor 11, or is drawn into the compressor 11. In these exemplary embodiments, the outlet 27 in the exterior heat exchanger 2 also has a fluid connection to the intake 26 in the chiller heat exchanger 3 through a fluid line 35 that bypasses the combination valve 6, which is also referred to below as a bypass connection 35. The outlet 27 in the evaporator heat exchanger 4 is also connected to the compressor 11 at the suction end of the compressor 11 by a fluid line 36, which is also referred to below as a return line 36. The outlet 27 in the chiller heat exchanger 3 is also connected to the return line 36 upstream of the outlet 27 in the evaporator heat exchanger 4. As can also be seen in FIG. 1, the electric vehicle battery 103 is interconnected to the bypass line 35 and the return line 36, such that the electric vehicle battery 103 can be cooled or heated as needed.

The outlet 27 in the chiller heat exchanger 3 is connected in these exemplary embodiments to the compressor 11 at the suction end of the compressor 11, such that refrigerant flowing from the chiller heat exchanger 3 flows to the compressor 11, or is drawn into the compressor 11. The outlet 27 in the exterior heat exchanger 2 in these exemplary embodiments also has a fluid connection to the intake 26 in the evaporator heat exchanger 4, such that refrigerant flowing out of the exterior heat exchanger 2 can flow to the evaporator heat exchanger 2 and subsequently to the compressor 11. As can also be seen in FIG. 1, there is a check valve 37 downstream of the outlet 27 in the evaporator heat exchanger 4 in these exemplary embodiments, which prevents refrigerant from flowing into the outlet 27 in the evaporator heat exchanger 4. There is also a check valve 37 downstream of the outlet 27 in the gas cooler heat exchanger 5, which prevents refrigerant from flowing into the outlet 27 in the gas cooler heat exchanger 5. There is also a check valve 37 in the bypass line 35 downstream of the outlet 27 in the exterior heat exchanger 2, which prevents refrigerant from flowing into the outlet 27.

As indicated by way of example in FIG. 1, it is possible to interconnect a heat exchanger 38 in the bypass line 35 and the return line 36, instead of, or in addition to, the electric vehicle battery, such that refrigerant flows through the heat exchanger 38 via the bypass line 35 and the return line 36. This heat exchanger 38 can also be referred to as an interior heat exchanger 38.

FIG. 27 shows an operating mode 39 of the circuit 1, in which the valve element assembly 19 is in the first heating setting 22. The operating mode 39 is also referred to below as the first heating mode 39.

FIG. 28 shows an operating mode 40 of the circuit 1, in which the valve element assembly 19 is in the second heating setting 23. The operating mode 40 is also referred to below as the second heating mode 40.

FIG. 29 shows an operating mode 41 of the circuit 1, in which the valve element assembly 19 is in the defrost setting 24. The operating mode 41 is also referred to below as the defrost setting mode 41.

FIG. 30 shows an operating mode 42 of the circuit 1, in which the valve element assembly 19 is in the cooling setting 25. The operating mode 42 is also referred to below as the cooling mode 42.

Those connections shown in FIGS. 27 to 30 through which fluid does not flow are indicated by broken lines.

In the first heating setting 22, and thus in the first heating mode 39, the air 8 that is to be supplied to the interior can be heated and dehumidified by heat obtained from the exterior and from the temperature control fluid, as well as from the air 8 that is to be supplied to the interior 101. The exterior heat exchanger 2 is thus used in this regard as a heat pump. The compressor 11 compresses the refrigerant flowing to the first entry 12 in the first heating mode 39. The refrigerant subsequently flows through the first exit 15 to the gas cooler heat exchanger 5 where it discharges heat. By discharging heat, the air 8 that is to be supplied to the interior 101 is heated. The refrigerant enters the exterior heat exchanger 2 downstream of the gas cooler heat exchanger 5, and acquires heat there, after which it returns to the compressor 11. The refrigerant also flows to the evaporator heat exchanger 4 and the chiller heat exchanger 3, after it has been choked in order to acquire heat by the respective expansion valves 9. Consequently, the air 8 that is to be supplied to the interior 101 can therefore be first cooled and dehumidified in the evaporator heat exchanger 4 in particular, and subsequently heated in the gas cooler heat exchanger 5. The refrigerant subsequently flows back to the compressor 11.

Heating and dehumidifying can also take place in the second heating setting 23, and thus in the second heating mode 40, as is the case in the first heating mode 39. Unlike in the first heating mode 39, however, heat is only acquired from the temperature control fluid, and the air 8 that is to be supplied to the interior 101 is only dehumidified by the evaporator heat exchanger 4. This means that the refrigerant cannot flow through the exterior heat exchanger 2.

The exterior heat exchanger 2 is defrosted, while the air 8 to be supplied to the interior 101 is heated in the defrost setting 24, and therefore the defrost mode 41. This defrost mode 41 may be necessary after longer operating times. The refrigerant flows from the compressor 11 through the first entry 12 and the first exit 15 to the gas cooler heat exchanger 5 in the defrost mode 41, in order to discharge heat to the air 8 that is to be supplied to the interior 101. The refrigerant subsequently flows to the exterior heat exchanger 2 to discharge heat into the exterior heat exchanger 2, and thus defrost any ice accumulated therein. The refrigerant flows to the chiller heat exchanger 3 downstream of the exterior heat exchanger 3, where it is expanded in order to accumulate heat from the temperature control fluid. The refrigerant subsequently flows back to the compressor 11.

The air 8 that is to be supplied to the interior 101 and the electric vehicle battery 103 can be cooled in the cooling setting 25, and therefore in the cooling mode 42. The refrigerant is pressurized in the compressor 11 in the cooling mode 42 to flow through the first entry 12 and the second exit 16 to the exterior heat exchanger 2, while bypassing the gas cooler heat exchanger 5. The refrigerant discharges heat into the environment, or ambient air 7 in the exterior heat exchanger 2, and is therefore cooled. The refrigerant subsequently flows to the evaporator heat exchanger 4 and/or chiller heat exchanger 3, where it is depressurized and cooled by the respective expansion valves 9, allowing the evaporator heat exchanger 4 and/or chiller heat exchanger 3 to acquire heat. The refrigerant subsequently flows back to the compressor 11.

The specification can be readily understood with reference to the following Numbered Paragraphs:

Numbered Paragraph 1. A refrigerant circuit (1), in particular for a motor vehicle (100),
wherein a refrigerant, in particular a refrigerant containing CO₂, circulates through the refrigerant circuit (1) when in operation,
which has an exterior heat exchanger (2) for exchanging heat in the refrigerant with the environment, in particular ambient air (7),
which has a chiller heat exchanger (3) for exchanging heat in the refrigerant with a temperature control fluid,
which has an evaporator heat exchanger (4) for exchanging heat in the refrigerant with air (8) to be supplied to an interior (101),
which has a gas cooler heat exchanger (5) for exchanging heat in the refrigerant the air (8) to be supplied to the interior (101),
which has a compressor (11), which pressurizes the refrigerant when in operation,
wherein the various heat exchangers (2, 3, 4, 5) have intakes (26) through which refrigerant is received, and outlets (27) through which the refrigerant is discharged,
which has a combination valve (6), which contains a first entry (12) that has a fluid connection to the pressurized end of the compressor (11), such that pressurized refrigerant flows through the compressor (11) to the first entry (12),
wherein the combination valve (6) contains a valve element assembly (10) with at least one valve element (20) and a housing (21) in which the valve element assembly (19) is housed such that it can be adjusted,
wherein the combination valve (6) is designed such that the valve element assembly (19) can be set to various settings, allowing or blocking the flow of the refrigerant to at least three of the heat exchangers (2, 3, 4, 5), such that the refrigerant is distributed in the refrigerant circuit (1) by the combination valve (6).

Numbered Paragraph 2. The refrigerant circuit according to Numbered Paragraph 1, characterized in that the combination valve (6) has three entries (12, 13, 14) and four exits (15, 16, 17, 18),
wherein a second entry (13) has a fluid connection to the outlet (27) in the gas cooler heat exchanger (5),
wherein a third entry (14) has a fluid connection to the outlet (27) in the exterior heat exchanger (2),
wherein a first exit (15) has a fluid connection to the intake (26) in the gas cooler heat exchanger (5),
wherein a second exit (16) has a fluid connection to the intake (26) in the exterior heat exchanger (2),
wherein a third exit (17) has a fluid connection to the intake (26) in the evaporator heat exchanger (4),
wherein a fourth exit (18) has a fluid connection to the compressor (11) at the suction end of the compressor (11).

Numbered Paragraph 3. The refrigerant according to Numbered Paragraph 2, characterized in that the valve element assembly (19) is designed such that in a cooling setting (25),
it has a fluid connection from the first entry (12) to the second exit (16),
it otherwise disconnects the entries (12, 13, 14) from the exits (15, 16, 17, 18),
such that refrigerant flowing through the first entry only flows through the second exit.

Numbered Paragraph 4. The refrigerant circuit according to Numbered Paragraph 2 or 3, characterized in that the valve element assembly (19) is designed such that in a first heating setting (22),
it has a fluid connection from the first entry (12) to the first exit (15),
it has a fluid connection from the second entry (13) to the third exit (17),
it has a fluid connection from the third entry (149 to the fourth exit (18),
it otherwise disconnects the entries (12, 13, 14) from the exits (15, 16, 17, 18).

Numbered Paragraph 5. The refrigerant circuit according to any of the Numbered Paragraphs 2 to 4, characterized in that the valve element assembly (19) is designed such that in a second heating setting (23),
it has a fluid connection from the first entry (12) to the first exit (15),
it has a fluid connection from the second entry (13) to the third exit (17),
it otherwise disconnects the entries (12, 13, 14) from the exits (15, 16, 17, 18).

Numbered Paragraph 6. The refrigerant circuit according to any of the Numbered Paragraphs 2 to 5, characterized in that the valve element assembly (19) is designed such that in a defrost setting (24),
it has a fluid connection from the first entry (12) to the first exit (15),
it otherwise disconnects the entries (12, 13, 14) from the exits (15, 16, 17, 18).

Numbered Paragraph 7. The refrigerant circuit according to any of the Numbered Paragraphs 1 to 6, characterized in that the at least one valve element (20) inside the housing (21) delimits at least one flow path (28), which has a fluid connection from one of the entries (12, 13, 14) to one of the exits (15, 16, 17, 18) in at least one of the settings (22, 23, 24, 25) of the valve element assembly (19).

Numbered Paragraph 8. The refrigerant circuit according to Numbered Paragraph 7, characterized in that at least one of the valve elements (20) has a channel (29) extending through the valve element (20), which delimits such a flow path (28).

Numbered Paragraph 9. The refrigerant circuit according to Numbered Paragraph 7 or 8, characterized in that at least one of the valve elements (20) has a recess (30) formed on its exterior, which delimits such a flow path (28).

Numbered Paragraph 10. The refrigerant circuit according to any of the Numbered Paragraphs 1 to 9, characterized in that at least one of the valve elements (20) is a cylinder (31) or a piston (31).

Numbered Paragraph 11. The refrigerant circuit according to any of the Numbered Paragraphs 1 to 10, characterized in that at least one of the valve elements (20) can move in a translatory manner in the housing (21) between at least two settings (22, 23, 24, 25).

Numbered Paragraph 12. The refrigerant circuit according to Numbered Paragraph 11, characterized in that the at least one valve element (20) that can move in a translatory manner is connected to a threading (34) extending along the translatory movement path, such that the valve (20) is moved by rotating the threading (34).

Numbered Paragraph 13. The refrigerant circuit according to any of the Numbered Paragraphs 1 to 12, characterized in that at least one of the valve elements (20) can rotate in the housing (21) between two settings (22, 23, 24, 25).

Numbered Paragraph 14. The refrigerant circuit according to any of the Numbered Paragraphs 1 to 13, characterized in that at least one of the valve elements (20) is a ball valve (32) and can rotate in the housing (21) between at least two settings (22, 23, 24, 25).

Numbered Paragraph 15. The refrigerant circuit according to any of the Numbered Paragraphs 1 to 14, characterized in that
the valve element assembly (19) contains a single valve element (20),
the valve element assembly (19) contains two adjacent valve elements (20).

1. A refrigerant circuit, in particular for a motor vehicle,
wherein a refrigerant, in particular a refrigerant containing CO₂, circulates through the refrigerant circuit when in operation, the refrigerant circuit comprises:
exterior heat exchanger for exchanging heat in the refrigerant with the environment, in particular ambient air,
a chiller heat exchanger for exchanging heat in the refrigerant with a temperature control fluid,
an evaporator heat exchanger for exchanging heat in the refrigerant with air to be supplied to an interior,
a gas cooler heat exchanger for exchanging heat in the refrigerant the air to be supplied to the interior,
a compressor, which pressurizes the refrigerant when in operation,
wherein the exterior heat exchanger, the chiller heat exchanger, the evaporator heat exchanger, and the gas cooler heat exchanger each have respective intakes through which refrigerant is received, and respective outlets through which the refrigerant is discharged,
the refrigerant circuit further comprises a combination valve, which contains a first entry that has a fluid connection to a pressurized end of the compressor, such that pressurized refrigerant flows through the compressor to the first entry,
wherein the combination valve contains a valve element assembly with at least one valve element and a housing in which the valve element assembly is housed such that it can be adjusted,
wherein the combination valve is configured such that the valve element assembly can be set to various settings, allowing or blocking the flow of the refrigerant to at least three of the group consisting of the exterior heat exchanger, the chiller heat exchanger, the evaporator heat exchanger, and the gas cooler heat exchanger, such that the refrigerant is distributed in the refrigerant circuit by the combination valve.

2. The refrigerant circuit according to claim 1, wherein the combination valve comprises a first entry, a second entry, and a third entry and comprises a first exit, a second exit, a third exit, and a fourth exit,
wherein the second entry has a fluid connection to the outlet in the gas cooler heat exchanger,
wherein the third entry has a fluid connection to the outlet in the exterior heat exchanger,
wherein the first exit has a fluid connection to the intake in the gas cooler heat exchanger,
wherein the second exit has a fluid connection to the intake in the exterior heat exchanger,
wherein the third exit has a fluid connection to the intake in the evaporator heat exchanger,
wherein the fourth exit has a fluid connection to the compressor at the suction end of the compressor.

3. The refrigerant according to claim 2, wherein the valve element assembly is configured such that in a cooling setting,
there is a fluid connection from the first entry to the second exit,
wherein the first entry, the second entry, and the third entry are each otherwise disconnected from the first exit, the second exit, the third exit, and the fourth exit, such that refrigerant flowing through the first entry only flows through the second exit.

4. The refrigerant circuit according to claim 2, wherein the valve element assembly is configured such that in a first heating setting (22),
there is a fluid connection from the first entry to the first exit,
there is a fluid connection from the second entry to the third exit,
there is a fluid connection from the third entry to the fourth exit, and
wherein the first entry, the second entry, and the third entry are each otherwise disconnected from the first exit, the second exit, the third exit, and the fourth exit.

5. The refrigerant circuit according to claim 2, wherein the valve element assembly is configured such that in a second heating setting (23),
there is a fluid connection from the first entry to the first exit,
there is a fluid connection from the second entry to the third exit,
wherein the first entry, the second entry, and the third entry are each otherwise disconnected from the first exit, the second exit, the third exit, and the fourth exit.

6. The refrigerant circuit according to claim 2, wherein the valve element assembly is configured such that in a defrost setting (24),
there is a fluid connection from the first entry to the first exit,
wherein the first entry, the second entry, and the third entry are each otherwise disconnected from the first exit, the second exit, the third exit, and the fourth exit.

7. The refrigerant circuit according to claim 1, wherein the at least one valve element inside the housing delimits at least one flow path (28), which has a fluid connection from one of the first, second, or third entries to one of the first, second, third, of fourth exits in at least one setting of the valve element assembly.

8. The refrigerant circuit according to claim 7 wherein at least one of the valve elements has a channel extending through the valve element, which delimits such a flow path (28).

9. The refrigerant circuit according to claim 7, wherein at least one of the valve elements has a recess formed on its exterior, which delimits such a flow path (28).

10. The refrigerant circuit according to claim 1, wherein at least one of the valve elements is a cylinder or a piston.

11. The refrigerant circuit according to claim 1, wherein at least one of the valve elements can move in a translatory manner in the housing between at least two settings.

12. The refrigerant circuit according to claim 11, wherein the at least one valve element that can move in a translatory manner is connected to a threading extending along the translatory movement path, such that the valve is moved by rotating the threading.

13. The refrigerant circuit according to claim 1, wherein at least one of the valve elements can rotate in the housing between two settings.

14. The refrigerant circuit according to claim 1, wherein at least one of the valve elements is a ball valve and can rotate in the housing between at least two settings.

15. The refrigerant circuit according to claim 1, wherein
the valve element assembly contains a single valve element.

16. The refrigerant circuit according to claim 1, wherein the valve element assembly contains two adjacent valve elements.
